(19) United States
(12) Patent Application Publication
(10) Pub. No.: US 2009/0234754 A1
(43) Pub. Date: Sep. 17, 2009

(54) Apparatus, a method, and a system for gemstone evaluation and gemology tutoring over the internet

(76) Inventors: Dave Lapa, Antwerpen (BE); Joe Srodawa, Morristown, NJ (US)

Correspondence Address: Feldman Law Group, P.C., 12 East 41st Street, NY, NY, 10017, US

(21) Appl. No.: 12/075,196

(22) Filed: Mar. 11, 2008

(51) Int. Cl. G06Q 30/00

(52) U.S. Cl. 705/27; 705/1

(57) ABSTRACT

A method of evaluating a gemstone over the internet is described that includes providing a server computer, providing access to an internet enabled device that is connectable to an apparatus capable of capturing an image of a gemstone, connecting the device to a second device through the server, and transmitting data over the internet of a received image of the gemstone to determine one or more optical properties of the gemstone

The method includes examining and purchasing a diamond or gemstone online, examining a diamond online and purchasing it at a retail establishment, conferencing with the seller and/or other persons online to examine the diamond online, and purchasing it online or at a retail establishment.

A system for gemstone evaluation over the internet is also included. The system comprises a server computer having a client device connectable to the internet for transmitting gemstone images and evaluating data, means for processing an image of a gemstone received from the apparatus to determine one or more optical properties of the gemstone, and means for presenting, on the display, the received image of the gemstone and representations of the determined one or more optical properties.

### BACKGROUND OF THE INVENTION

1. Field of the Invention

The present invention relates to an apparatus and a computer-implemented method and system for gemstone evaluation and gemology teaching in an internet environment.

2. Description of the Related Art

It is difficult for an untrained observer or buyer to appreciate the beauty of a gemstone, such as a diamond, without the help of a person trained and skilled in gemology. The apparatus, methods, and systems for gemstone evaluation in general and cut diamond evaluation in particular require that the person using them have specialized knowledge of gemology. It usually takes a long time for a person to learn to use the methods and systems. Thus, to an untrained buyer, these methods and systems do not offer a ready, easy, and complete solution for gemstone evaluation.

With the advent and the proliferation of internet shopping, more and more buyers are now buying precious stones over the internet. The users who want to buy gemstones over the internet either do not have or access to gemstone evaluation tools, or an evaluation apparatus or a gemology expert, or time to learn these difficult-to-master drills. This lack of expert help is especially felt when the user is buying gemstones on somewhat of an impulse buying decision, such as buying a diamond for a wedding ring. Diamonds are evaluated based on 4 C's: carat weight, clarity, color and cut. The effects of these four C's on the evaluation of a diamond are not something that an untrained buyer can estimate without professional advice from gemology experts, without using specialized gemology tools, and without spending time and thought on understanding how to apply the tools.

In such a situation, the internet gemstone shopping experience needs an apparatus, a method, or a system that is not only easy to understand and use, but also makes it quicker and easier for untrained buyers to appreciate and compare the beauty of gemstones, such as by educating them about 4 C's and the phenomenon of ‘hearts’ and ‘arrows.’ A method is needed that enables reliable and objective evaluation of a gemstone stone such that buyers assured of the quality of the gemstone can place an order over the internet and obtain the gemstone through the mail without having to leave their home. A method is needed to see the gemstone online and purchase it in a retail store.

What is needed then is an apparatus and computer implemented method and system for gemstone evaluation, gemstone shopping, and gemology teaching in an internet environment. One that is easy to use that encourages even an untrained user to assess the beauty of a gemstone as well as to remotely compare one gemstone against others.

### SUMMARY OF THE INVENTION

A method of evaluating a gemstone over the internet is described that includes providing at least a server computer for providing access to an internet enabled client. The client is connected to a client apparatus capable of capturing an image of a gemstone through a server over the internet to process a received image of the gemstone to determine one or more optical properties of the gemstone.

The method will present, on a display of the client, a series of screens comprising a graphical representation of how a cut of a gemstone affects its light handling ability. The method further includes presenting, on the display of the client, a user interface screen. The user interface screen configuration allows controlling an operation of the apparatus to measure one or more optical properties of a particular gemstone provided to the apparatus, view an image of the gemstone so measured, and view representations of the measured one or more optical properties. The method of evaluating gemstones also includes the server computer providing a gemstone database and/or a teaching database.

The method includes examining and purchasing a diamond or gemstone online, examining a diamond online and purchasing it at a retail establishment, conferencing with the seller and/or other persons online to examine the diamond online and purchasing it online or at a retail establishment. Further, it can include examining the diamond through virtual equipment online and then purchasing the diamond online or at the store.

A system for gemstone evaluation over the internet is also included. The system comprises a server computer having a client device connectable to the internet for transmitting gemstone images and evaluating data, means for processing an image of a gemstone received from the apparatus to determine one or more optical properties of the gemstone, and means for presenting, on the display, the received image of the gemstone and representations of the determined one or more optical properties.

### BRIEF DESCRIPTION OF THE DRAWINGS

These and other aspects of the invention will become apparent from the following description read in conjunction with the accompanying drawings, in which:

FIG. 1A illustrates an internet-enabled environment for performing the present invention;

FIG. 1B is a block diagram of a method of the present invention;

FIGS. 2A and 2B illustrate perspective views of a standard round brilliant cut diamond;

FIG. 2C illustrates a cross-sectional view of an apparatus for measuring optical properties of a gemstone;

FIGS. 3A and 3B illustrate the surface of the apparatus of FIG. 2 having exemplary patterns of relatively reflective and relatively unreflective regions;

FIG. 4A is a schematic diagram showing the logical components of the present invention;

FIG. 4B is yet another schematic diagram showing the logical components of the present invention;

FIGS. 5A-5H are flow diagrams showing the processes of the present invention;

FIG. 6 is a screenshot of the main menu page of the present invention;

FIGS. 7A and 7B are exemplary screenshots of the pages of an internet-enabled web application of the present invention that explain the significance of the four ‘C’s of diamonds and the geometry and proportions of a modern SRB cut diamond;

FIGS. 8A-8C are screenshots of the pages of an internet-enabled web application of the present invention that explain the significance of the difference between shallow, deep, and ideal SRB cut diamonds in terms of the process of cutting a rough diamond and carat weight;

FIGS. 9A and 9B are exemplary screenshots of the pages of an internet-enabled web application of the present invention that explain the significance of the differences in light handling ability between, deep, shallow, and ideal cut SRB cut diamonds;

FIGS. 10A and 10B show screenshots representing the gemology teaching pages that explain how an ideal SRB cut diamond is cut from a rough to produce the phenomenon of “hearts and arrows” in a well-cut diamond.

FIGS. 11A-11D are screenshots of an internet-enabled web application of the present invention that is used for controlling the operation of the apparatus for measuring properties of a gemstone and for viewing the gemstone and representations of optical properties of the gemstone; and

FIGS. 12A-12C are screenshots of an internet-enabled web application of the present invention that is used for viewing reports on gemstones.

### DETAILED DESCRIPTION OF THE INVENTION

The present invention is directed to a person looking at and buying a diamond through the internet, including buying the diamond on the internet, buying the diamond at a retail store after reviewing it on the internet, conferring with the seller through the internet, and buying the diamond on the internet or at the seller's store.

The present invention is also directed to examining the diamond through virtual equipment online and purchasing the diamond online or at the store.

The present invention also includes online assistance in evaluating and/or purchasing the diamond.

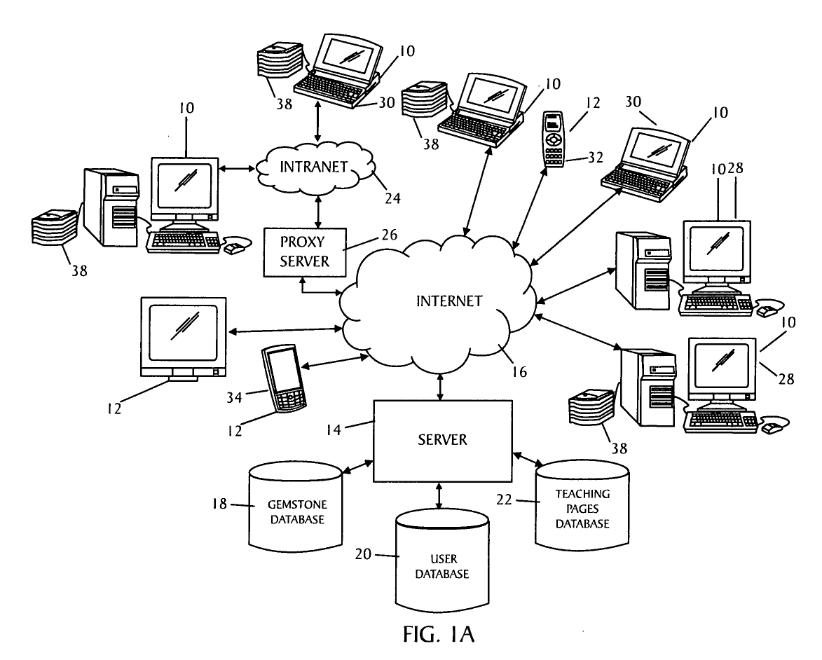

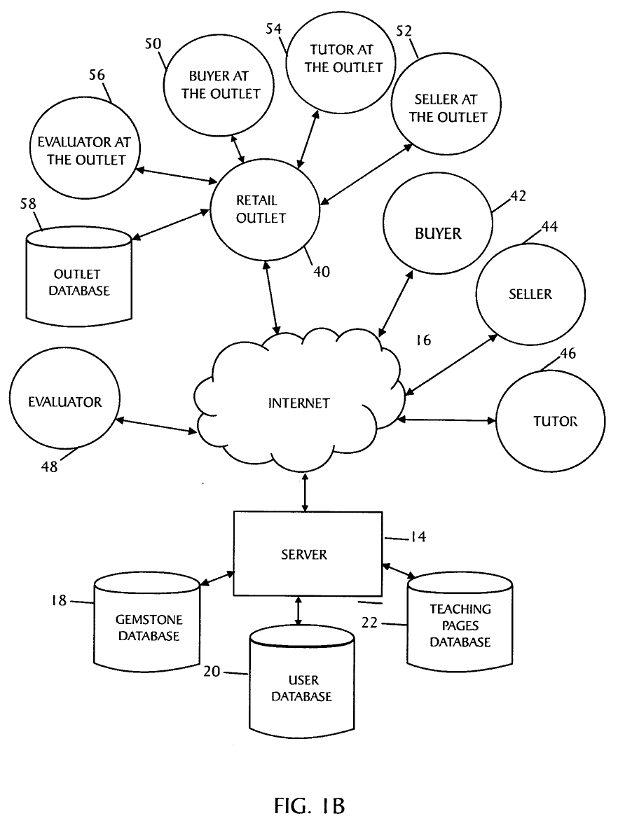

FIG. 1A illustrates an example of an internet-enabled environment for evaluating and reviewing diamonds online. Client computers 10 and internet-enabled devices 12 retrieve documents, such as web pages and Adobe Flash presentations as well as data stored on a server 14 related to the diamond. The server 14 has a gemstone database 18 that stores information about gemstones, a teaching database 20 that stores information about various aspects of gemstone evaluation and gemology, and a user database 20 that stores information about users using the server resources. The client's computer 10 and internet enabled devices 12 are coupled to the server 104 via the internet 16. Some client computers 10 that are located on the intranet 24 communicate indirectly with the server via a proxy server 26. The client's computer 10 may consist of either workstations 28 or laptops 30. The internet enabled devices may consist of cellular phones 32, personal digital assistants (PDAs) 34, and cable TVs 36. Furthermore, some of the client computers may be coupled to gemstone evaluation apparatus 38. In one embodiment, only one server 14 is used. A plurality of servers, however, can be used in alternative embodiments so that documents and databases can be located on a distributed network of servers.

FIG. 1B illustrates a role based high-level block diagram of the internet enabled environment for performing the present invention. A user connects to the server 14 via the internet 16 to access the diamond or gemstone documents and data stored on databases 18, 20 and 22. It should be noted that the term “user,” for example, includes a retail outlet 40, a buyer 42, a seller 44, a tutor 46, and/or an evaluator or grader or others 48.

Buyers 42, sellers 44, tutors 46, and evaluators 48 directly connect to the server 14 using the Web front of the server 14. The retail outlets connect to the server either directly using the Web front of the server 14 or indirectly using a retail outlet server that is coupled with server 14. The retail outlets further include a plurality of sub-users. The plurality of retail sub-users includes buyers 50, sellers 54, tutors 56 and evaluators 58.

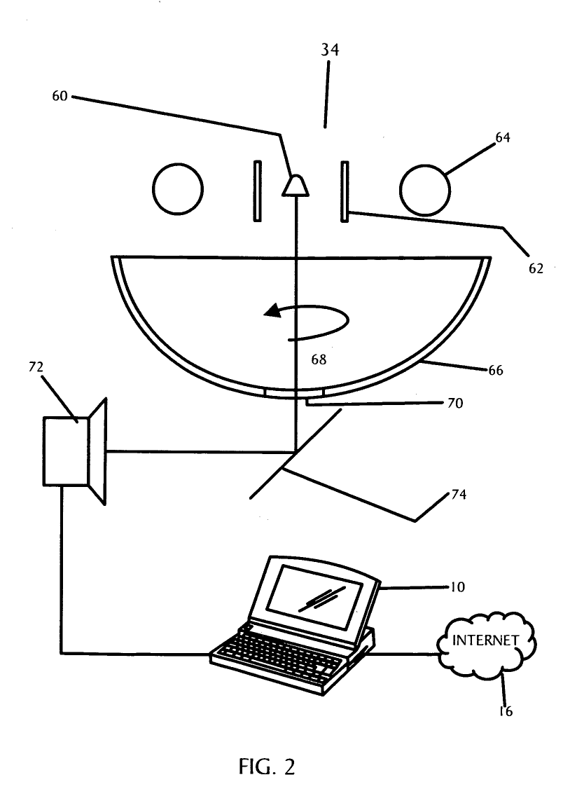

FIG. 2A shows the geometry of a standard round brilliant diamond 60 also known as the SRB diamond. The top most dome-shaped portion of the diamond is known as the crown 62. The bottom most conical portion of the diamond 60 is the pavilion 64. A relatively large facet centered on the top of the crown is known as the table 68. The bottom most part of the pavilion is known as the culet 66. FIG. 2B shows a top-down view of the SRB diamond 60 taken along an axis from the center of the table 68 through the culet 66. The SRB cut diamond may have fifty six radial facets that include twenty four facets on the pavilion 64 and thirty two facets on the crown 62. The fifty six radial facets do not include the table 14 and the culet 16, and present an 8-fold symmetry about the axis passing though the center of table 14 and culet 16.

FIG. 2C shows a cross-sectional view of a gemstone evaluation apparatus 34 that may be used with the present invention. Arranged within the apparatus 34, there is a platform (not shown) made of an optically clear glass plate of regular thickness such as that of a window pane. A diamond 60, is placed at an observation position. The diamond 60 is placed such that the table-side is face-down on the platform. The platform is arranged to be in a substantially horizontal position when the apparatus 34 is in a horizontal position. An anti-reflection coating is applied to the platform to reduce glare. The platform is also provided with a small ring underneath to further reduce glare. The apparatus 34 is mounted in a housing (not shown), which is designed to prevent external light from reaching the diamond 60, as well as, dust from entering the mechanical and optical components. The housing is provided with an access lid (not shown) above the platform. The access lid is for replacing and removing a gemstone to be measured. The inner surface of the housing and the access lid are coated with nonreflective material. The purpose of the coating is to substantially negate the reflection of light from the lid or the housing towards the gemstone or the platform.

An annular light 70 is preferably used to illuminate the diamond 60. The annular light 70 emits visible light of frequency comparable to daylight, such as fluorescent tube light or halogen. A microscope illuminator with the annular light source may be directly attached to a microscope. The microscope illuminator and the microscope have a wide range of magnification options that allow users to switch between low magnification for inspection and fine detail magnification for closer examination for imperfections. The housing of the apparatus 34 also contains adjusting and focusing means for the annular light 70 and a concave mirror for vertical adjustment of the light source. The mirror may also be adjusted to change the focus and the lateral alignment.

An annular baffle 72 is disposed between the annular light 70 and the diamond 60 to prevent the light from annular light 70 from directly reaching diamond 60. A reflector, preferably a semi-spherical shell, is centered on the observation position. The inner surface of the shell is a concave surface 74 that substantially reflects light from annular light 24 towards diamond 60.

The reflector is mounted within the apparatus 34. The arrangement of the reflector is such that concave surface 74 is rotatable about axis 76 which is perpendicular to the platform. The arrangement also allows the center of the table and the culet to lie approximately along the axis 76. Annular light 70 and annular baffle 72 are disposed stationarily within the apparatus 34 such that both are significantly perpendicular to and centered about axis 76. The apparatus 34 may be provided with a motor, such as a stepper motor (not shown) that is connected to computer 10 and controllable by the computer 10. The stepper motor rotates the reflector and concave surface 74 about axis 76.

A viewing hole 78 is provided at the bottom of the reflector and the concave surface 74. The viewing hole 34 is situated where the reflector and the concave surface 74 meet axis 76. A digital camera 80 is positioned within the apparatus in order to capture an image of diamond 60 along the axis 76. The camera 80 is connected to and is capable of being controlled by computer 10. The memory is capable of storing at least one image and a data communication interface for transferring captured image data to an external device, such as a computer 36. The camera 80 is enabled to capture images at various magnifying options using a microscope illuminator attached to the microscope.

The data communication interface is preferably compatible with standards such as the Universal Serial Bus (USB) or FireWire. The computer 10 is coupled either to the internet 16 or an intranet 24. When images are captured, the camera 80 is focused on the plane made by the topmost surface of the platform on which diamond 60 is placed. An optically clear mirror 82 is preferably disposed within the apparatus and arranged so that the light path between camera 80 and diamond 60 does not have to be a straight line. The arrangement of clear mirror 82 enables a more compact format of the apparatus. Thus, the apparatus 34, including the light 70, baffle 72, reflector with concave surface 74, mirror 82, stepper motor, camera 80, and housing is compact in size and lightweight.

The computer 10 controls the stepper motor to rotate concave surface 74 using a suitable computer program. The surface 74 is rotated through a series of predetermined rotational positions. A camera 80 is also controlled by the computer 10 to capture images of diamond 60 at a suitable frame rate; a frame rate such that an image is stored at each of the series of rotational positions of concave surface 74. The image data captured by camera 80 is transferred to computer 36 in the form of a suitable image file format for display and analysis, and is transmitted as a continual live image feed to the computer 10. The live image feed is further transmittable to either computer 10 or internet-enabled device 12 over either the internet 16 or an intranet 24.

The symmetry of the light pattern reflecting off concave surface 74 decides the range of angles through which concave surface 74 is rotated. Images are captured at a plurality of rotational positions as concave surface 74 is rotated through a 90° range. The number of images captured at different rotational positions for use in analysis depends on the cut of the gemstone being measured, or the cut of the most similar faceted gemstone likely to be measured (within the 90° range). The number of images captured is preferably at least 4 times the number of differently angled facets within the range through which concave surface 74 is rotated. The concave surface 26 is rotated in steps of 20 over a 90° range. Higher or lower numbers of images may be used as appropriate to the cut pattern of the gemstone, the accuracy of measurement required, and the processing capabilities of the computer 10. In one embodiment, the concave surface 74 may be held stationary rather than rotated. In yet another embodiment, the concave surface 74 may be held stationary while the camera 80 is rotated.

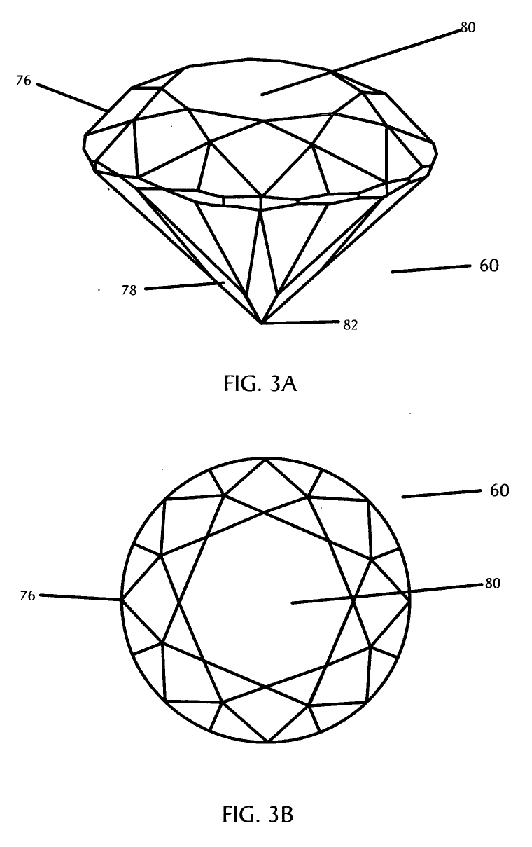

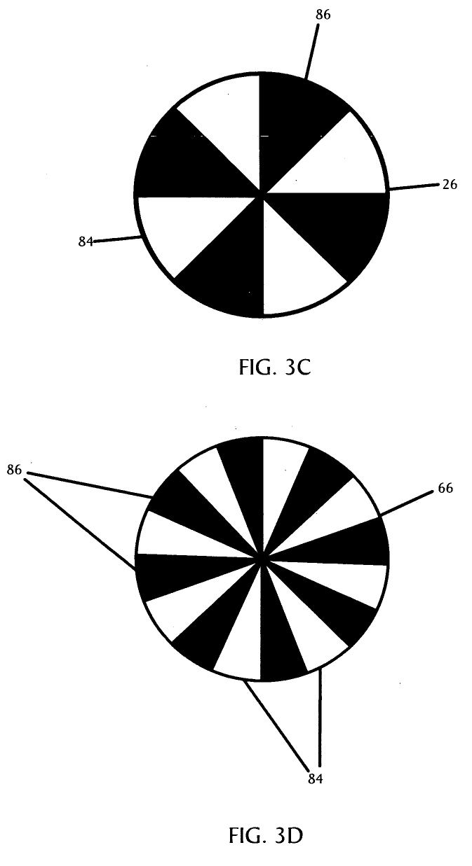

FIGS. 3A and 3B show the concave surface 74 looking down from the diamond observation position along axis 76. The concave surface has a plurality of relatively reflective regions 84 and a plurality of relatively unreflective regions 86. The plurality of relatively reflectively regions 84 is formed by coating the surface with relatively reflective materials. The plurality of relatively unreflective regions 86 is formed by coating the surface with relatively unreflective materials. FIG. 3A shows one configuration of regions 84 and 86. The configuration presents a concave surface 74 that is divided into eight equal radial sectors, alternately reflective and unreflective, arranged around the axis 76. The configuration of regions 84 as well as the configuration of regions 86 has a 4-fold symmetry. FIG. 3B shows another configuration of regions 84 and 86. The configuration presents concave surface 74 that is divided into sixteen equal radial sectors, alternately relatively reflective and relatively unreflective surfaces, arranged around the axis 76. The configuration of regions 82, as well as, the configuration of regions 84 has 8-fold symmetry. Apart from these two configurations, other configurations of relatively reflective regions 40 and relatively unreflective regions 42 are also possible within the scope of the present invention.

The light reflecting off concave surface 74 towards the diamond 60 at its observation position present a spatially varied pattern during operation of the apparatus 34. The spatially varied pattern is determined by the configuration of reflective regions 84 and unreflective regions 86. The light pattern observed in the plane of the platform presents a series of radial peaks and troughs that have light intensity corresponding to the configuration. Thus, the light pattern that has four radial peak lines and four radial trough lines represents the configuration of FIG. 3A. The light pattern has eight radial peaks and eight radial troughs and is shown in FIG. 3B. In addition, the light is generally reflected towards the crown at a broad range of angles of incidence relative to axis 74 with diamond 60 table-side down on the platform.

The cut of a diamond 60 determines the selection of a particular configuration of relatively reflective regions 84 and relatively unreflective regions 86. The SRB cut diamond 60 of FIG. 3B has an eight-fold symmetry and has a configuration of regions 84 and 86 with eight sectors that are relatively reflective 84 and four relatively unreflective sectors 86. The light pattern, reflecting off concave surface 74, with four radial peaks and four radial troughs, corresponds to the symmetry of the cut gemstone. Thus, adjacent symmetrical sectors of the gemstone of 45° each receive corresponding radial light pattern sectors of 45° each with adjacent peaks and troughs. The intensity of light, as observed at any radial line in the plane of the platform, and about axis X, goes through a single complete cycle that has a single peak and a single trough, as concave surface 74 is rotated through 90°.

Apart from the SRB cut diamond, the algorithms used to determine the periphery of the gemstone and the various measurements of optical properties, as described above, may be varied to take into account different shapes and/or symmetries of particular gemstone cut patterns, such as square, oval, pear, heart-shaped or irregular shapes. Similarly the configuration of relatively reflective regions 40 and relatively unreflective regions of concave surface 26 may be varied to take into different shapes and/or symmetries of particular gemstone cut patterns.

The following discussion covers the operation of both the live experience and the remote experience. The live experience involves examining an actual diamond over the internet and buying it at the store where it is located or buying it over the internet. The remote experience involves examining online pictures of the diamond and buying the diamond online or at the store. In both procedures, the purchasing may involve receiving the seller's assistance as well as other assistance. In the live experience, an evaluation equipment exists, and in the remote, the evaluation equipment may be real or virtual.

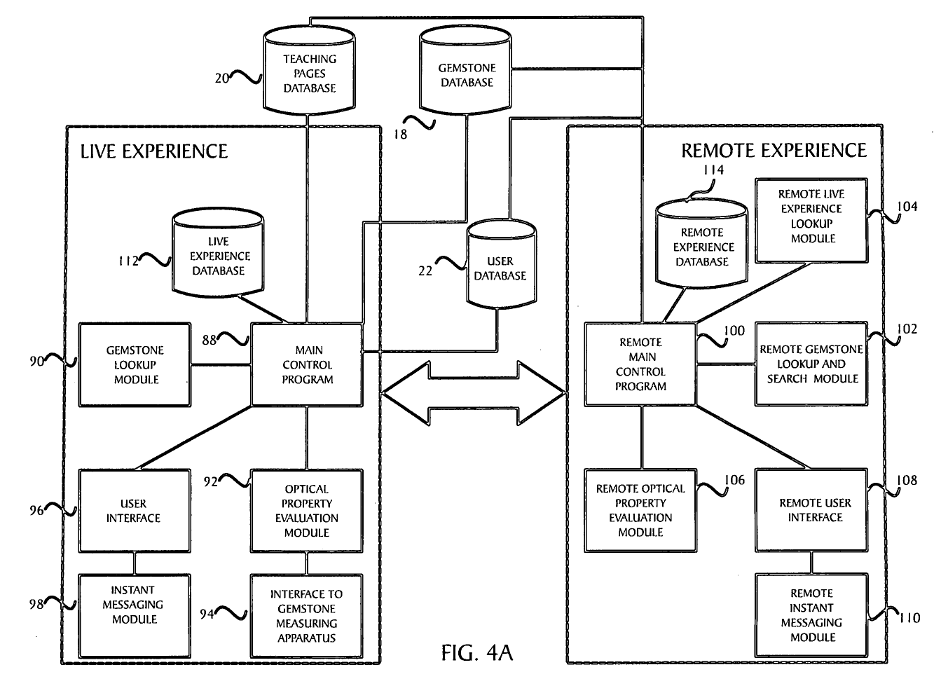

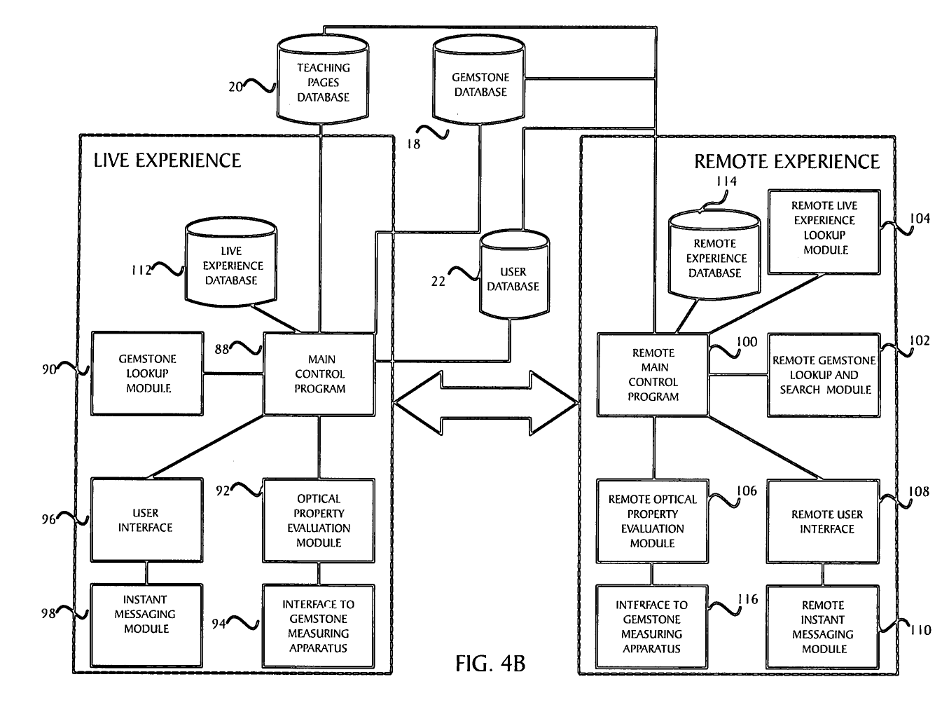

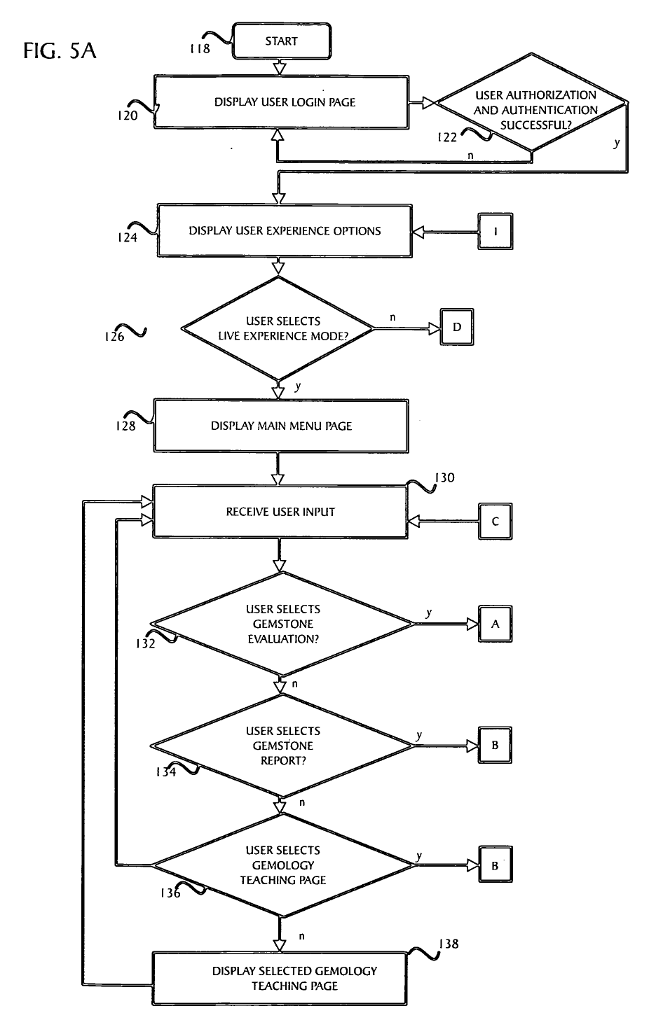

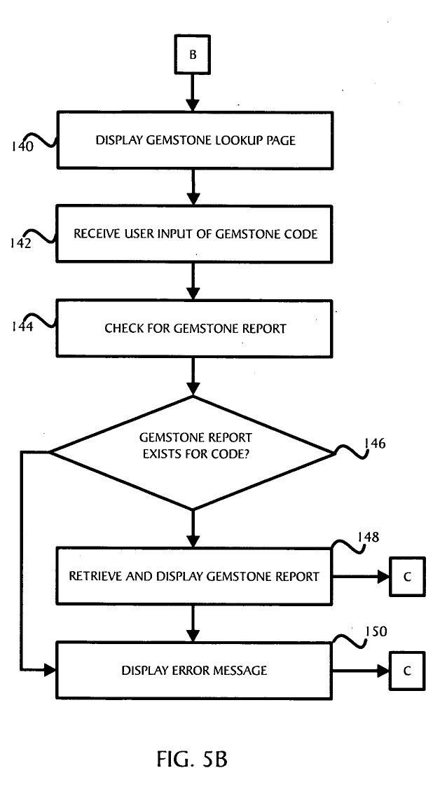

FIG. 4A shows a schematic diagram showing logical components of the present invention. The schematic diagram has a live experience component that is connectible to a remote experience component via the internet 16 or an intranet 24. The live experience means that the user (potential buyer) can examine an actual diamond online and either buy it in a retail establishment or buy it online. The buyer can also video conference with a seller and/or other persons online to examine the diamond online and either purchases it online or at a retail establishment. In addition, the user can consult online with customer relationship management (CRM) of seller or evaluator with the seller to discuss and evaluate the diamonds. One of the roles of CRM is to provide helpful information regarding diamonds.

The live experience component has a main control program 88 that controls the presentation of gemstone reports that are stored in a gemstone database 18. It may include other gemology pages that are stored in a teaching database 20. The main control program gives the user access to database 22 that store information. The gemstone reports are submitted when the user looks up particulars of a gemstone using a look-up module 90. The gemstones are preferably accessed using unique gemstone IDs or codes, or other criteria. Databases 18, 20, 22 are databases on the internet which include standard practices for data security, transaction management, and client-side validation.

Main control program 88 is capable of launching optical property evaluation module 92 as a sub-program. Optical evaluation module controls the operation of and receives data from apparatus 34 via an interface 94 to gemstone measuring apparatus 34. The interface 56 drives the ports connected to the apparatus 34 for determining optical properties of a gemstone. A user interface 96 controls the display, sound system, keyboard, pointing device and connection to the server 14 for the live experience user. It is via the user interface 96 that gemstone reports, the user interface screens for operating the apparatus, screens showing the results of evaluation, and screens showing particulars of a gemstone are all presented.

Main control program 88 has a Web-like front end. The front end is preferably composed of a plurality of hyperlinked Hypertext Markup Language (HTML). These pages can be viewed using any Web browser application, such as Netscape, Firefox and the Microsoft internet Explorer for example. The HTML pages are hyperlinked to form a menu structure. The user navigates through the menu structure to use various sub-programs of the main program 88. In the preferred embodiment, the HTML pages present Adobe Flash presentations to the live experience component user. The live component user can view the Adobe Flash presentations after installing and enabling Adobe Flash player for the Web. The HTML pages and the Flash presentations are preferably stored on server 14. Gemology teaching pages together with the main menu page and gemstone report viewing pages are stored in database 18.

Main control program 88 is capable of receiving user input from a live experience user via user interface 96. The user typically clicks on a hyperlink or allows the pointing device to hover over a hotspot, to control the presentation of gemology teaching pages, to look-up gemstone reports using gemstone look-up module 90, or to launch the optical property evaluation module 92. The live experience component is enabled to transmit the data or the output generated by various modules, such as the optical property evaluation module, over the internet 16 or the intranet 24 to server. The data or the output generated by various modules is transmitted to remote users through server 14. The live experience component is enabled to exchange data with another user over the internet 16 either through server 14 over the intranet 24 or through proxy server 26 that is also connected to the server 14 through internet 16. The live experience component also has an instant messaging module 98 that enables audio, visual and textual communication with another user such as a seller or grader or both either over the internet 16 or over the intranet 24. This allows the buyer to confer with the seller through the internet and buy the diamond at the seller's store. The remote live experience component has a remote main control program 100 that controls the presentation of gemstone reports stored in gemstone database 18, gemology pages that are stored in teaching pages database 20. The remote main control program 100 also gives users access to database 22 that stores information about users that are using the server 14. The remote experience component has a remote gemstone lookup and search module 102 for the purpose of gemstone identification. The remote gemstone lookup and search module 102 are also capable of searching gemstones by gemstone code. The live experience component has a remote live experience search module 104 that gives live experience options available to the remote experience user. The remote user, for example, may select a remote live experience option based upon various criteria, such as location, name of the gemstone retailer, and other live users, such as graders or evaluators that are available online at a given time. The remote experience involves online pictures of the diamond and buying the diamond online or at the store. As in the case of the live experience, the user can also confer with a seller or grader online. Also, the user may contact CRM online.

The remote main control program 100 is also capable of launching remote optical evaluation module 106 as a sub-program. Remote optical evaluation module 106 for the live user controls the operation of and receives data from apparatus 34 via interface 94 to gemstone measuring apparatus.

A remote user interface 108 drives the display, sound system, keyboard, pointing device, and connection to the internet of the remote live experience user. It is via the remote user interface 108 that gemology teaching pages, gemstone reports, user interface screens for operating the apparatus, screens showing the results of evaluation, and screens showing particulars of a gemstone are all presented.

Remote main control program 100 has a Web-like front end. The Web-like front end is composed of a plurality of hyperlinked Hypertext Markup Language (HTML). These pages can be viewed using any Web browser application, such as Firefox and the Microsoft Internet Explorer. The HTML pages are hyperlinked to form a menu structure. The user navigates through the menu structure to use various sub-programs of the main program 100. In one embodiment, the HTML pages comprise embedded Adobe Flash presentations. The user can view the Adobe Flash presentations after installing and enabling Adobe Flash player for the Web. The HTML pages and the Flash presentations are preferably stored on server 14. Gemology pages together with the main menu page and gemstone report viewing pages are stored in the teaching pages database 20.

Remote main control program 100 is capable of receiving user input from the remote live experience user via the remote user interface 108. The remote live experience component is enabled to transmit and receive data over the internet through server 14.

In addition to databases 18, 20, 22, preferably stored on server 14, the live experience component may have live experience database 112 for storing live experience data. Also, the remote experience component may have remote experience database 114 for storing remote experience data. The remote experience component may also include a remote instant messaging module 110.

FIG. 4B is a variation of schematic diagram of FIG. 4B where the logical composition of the remote experience component is identical to that of the live experience component. As mentioned above, the remote experience allows a user to evaluate a diamond online by looking at virtual diamond images. After the user evaluates the diamond, the user can then either purchase the diamond online or buy it at a retail establishment. As in the case of the live experience, the user can also confer with a seller or grader online. The remote interface 116 drives the ports connected to a remote apparatus for determining optical properties of a gemstone. The remote experience component may work as a live experience component when it initiates the process. In this arrangement, the live experience component is capable of receiving data of a remote diamond evaluated via the remote interface 116 of the remote experience component over the internet through server 14. The remote live experience component is enabled to exchange data with the live experiment component.

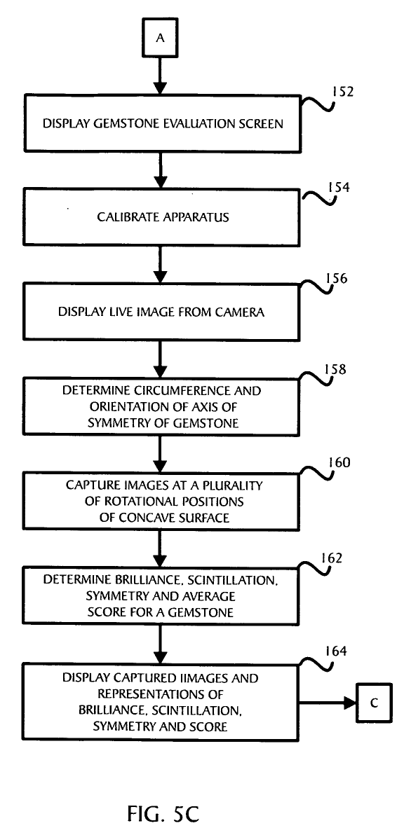

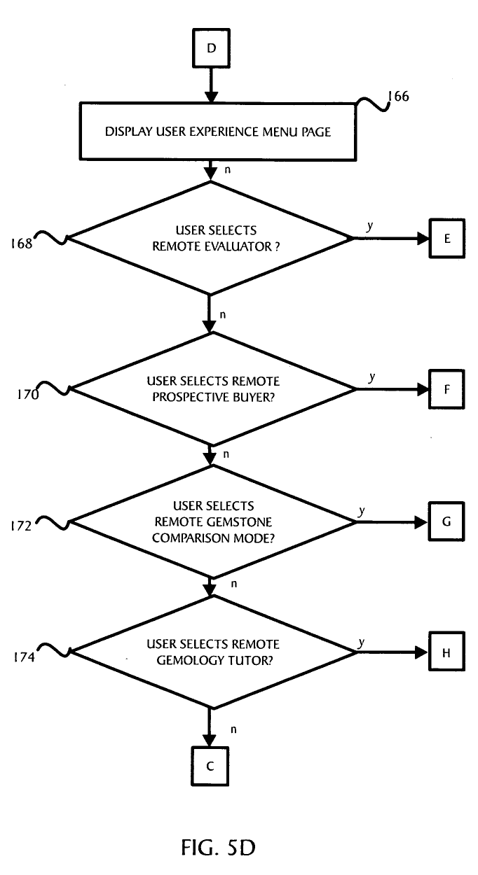

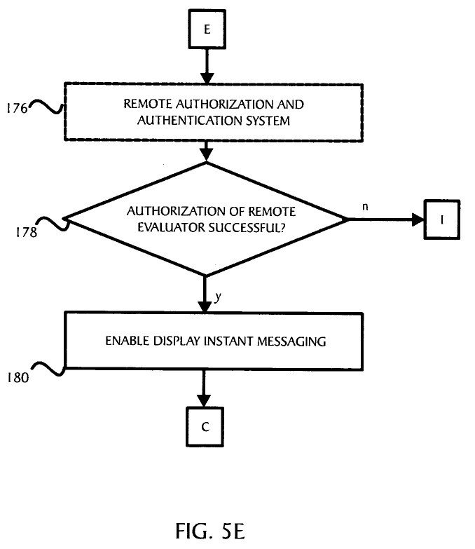

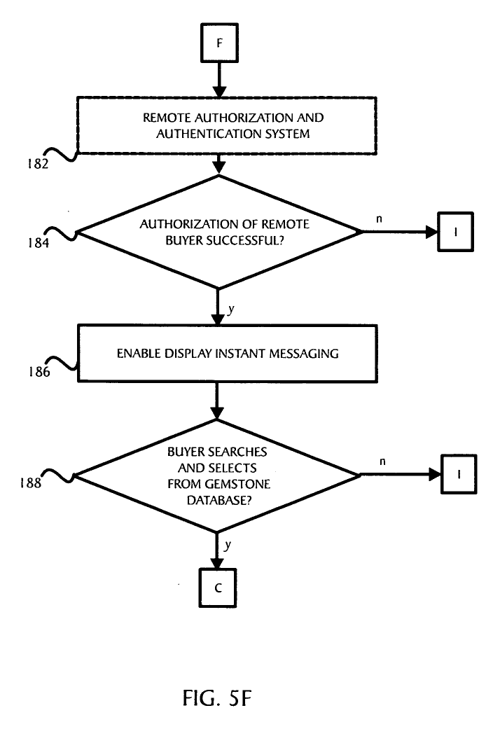

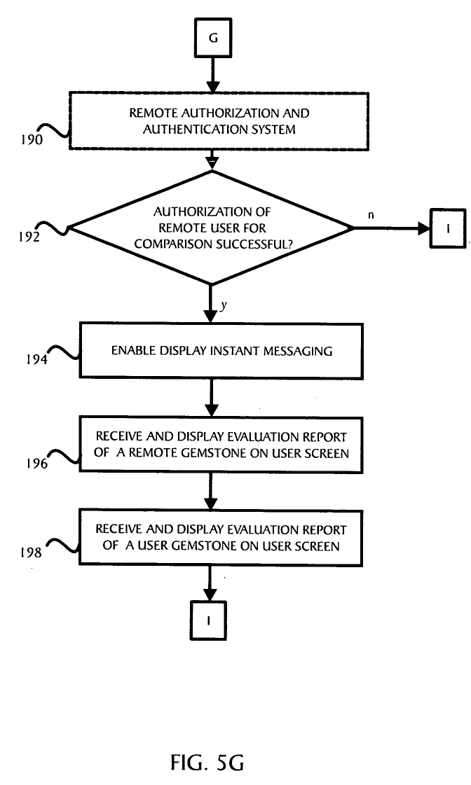

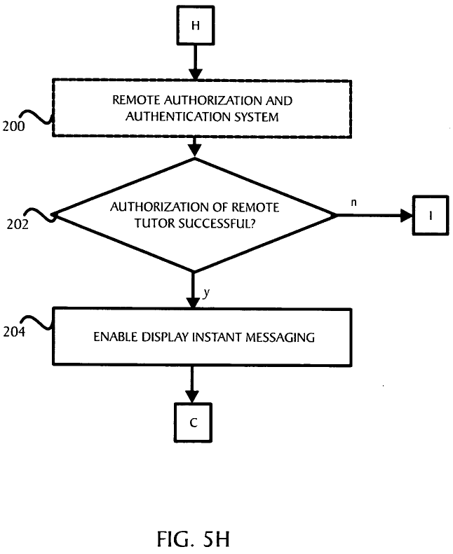

FIG. 5A a simple flow diagram that shows the process after the main control program 88 is launched. The process starts at step 118 when the main control program 88 is first launched. At step 120, the user is presented with a log-in page for authorization and authenticating access to the parts of the gemology teaching and gemstone evaluation application located on server 14. At step 122, it is determined whether the user is successful in completing authorization and authentication process. If the user does not complete the authorization and authentication process successfully, the step goes back to step 120, otherwise, the process continues to step 124. At step 124, a page showing the user experience options is displayed and the user can choose between remote experience mode and live experience mode. At step 126, it is determined whether the user has selected the remote experience mode or the live experience mode. If the user does not select the live experience mode, the process moves to point D, otherwise, the process continues to step 128. At step 128, a main menu page is displayed for the user to enter the user's input. The process then continues to step 130. At step 130, the user's input is received via user interface 96. The process then continues to step 132. At step 132, it is determined whether the user has selected the optical property evaluation module 92 for gemstone evaluation. If this is the case, the process continues to point A at FIG. 5A. If not, the process continues to step 134, where it is determined whether the user has selected to look-up a gemstone from gemstone database 18 using gemstone look-up module 90. In this case, the process continues to B at FIG. 5B. If not, the process continues to step 136, where it is determined whether the user has selected a particular gemology page to display from pages database 20. The process then continues to step 138 where the appropriate page is displayed. The process then returns to step 130 where user input is received via user interface 96. If not, the process directly returns to step 130.

Optical property evaluation module 92 controls the operation of apparatus 34 and has the capability to receive data generated by apparatus 34. The optical evaluation module 92 analyzes the received gemstone data and displays the results using user interface 96. The optical property evaluation module 92 may be arranged to control a motor, such as a stepper motor, to rotate concave surface 74 and to control camera 80 to capture and transfer to the computer 10 images of diamond 20 at each of the predetermined rotational positions. Using a conventional stepper motor control circuit to interface between computer 10 and the stepper motor, control over the stepper motor is achieved. For sending digital control signals to the stepper motor control circuit, apparatus interface 94 on computer 36 has a standard program. The camera 80 is controlled using the camera's inbuilt control interface. The apparatus interface 94 has program elements for sending digital control signals to camera 80.

The user interface 96 controls the optical property evaluation module 92, which controls apparatus interface 94 on computer 36. The user is able to send instructions via user interface module 96 to capture a series of images of a gemstone and transfer these images from camera 80 to computer 10. The user is able to analyze the images to obtain measurements of optical properties of the gemstone and display the images and representations of the optical properties on the screen of the computer 10.

FIG. 5B shows a simple flow diagram that represents the process followed by main control program 88 from point B. A gemstone report look-up page is displayed at step 140 and the process continues to step 142, where the gemstone look-up module 90, such as a Java Applet, receives a gemstone code input by the user. At step 144, the gemstone look-up module 90 searches gemstone database 18. At step 146, it is determined whether a gemstone report for the gemstone corresponding to the input gemstone code exists in gemstone database 18. If this is the case, the process continues to step 148, where the gemstone report is displayed and the process continues to C. If not, the process continues to step 150, where an appropriate error message is displayed. If at step 148, the gemstone report is not retrieved and displayed, the process continues to step 150 where an appropriate error message displayed.

FIG. 5C is a simple flow diagram that represents the process followed by optical property evaluation module 92. The optical property evaluation module is arranged to wait for user input between each of the steps 152, 154, 154, and 156 as shown in FIG. 5C. At step 152, the gemstone evaluation screen is displayed. The apparatus is then calibrated at step 154 by taking an image of a known portion of concave surface 74 and measuring the intensity of light at three areas of the image. At step 156, by allowing the user to place a diamond table-side down on the platform of apparatus 34, a live image is displayed. At step 158, the circumference of the diamond and orientation of the diamond about the axis of symmetry is calculated. The process then continues to step 160, where the stepper motor is controlled to rotate concave surface 74 through a plurality of rotational positions. Images are captured and stored on the hard disk of computer 10 for each position. At step 162, the brilliance, scintillation, and symmetry of the diamond are determined using algorithms and an overall score is displayed. The process terminates at step 164, where the captured images are displayed in sequence to produce a moving image of the diamond. The representations of the determined optical properties of brilliance, scintillation and symmetry are then displayed as bar charts. The process then continues to point C.

Three separate algorithms are used to calculate the three measures of brilliance, scintillation, and symmetry from the stored images. The optical property evaluation module 92 first analyzes the images to determine the circumference of the gemstone and its center point. The circumference is determined by summing the light intensity levels at each pixel over the images at different rotational positions to obtain a composite image. Then, all pixels are selected of the composite image that have a light intensity level above a predetermined threshold that represents a light level slightly above the level of the black background. The smallest circle that contains all the selected pixels is then determined and this circle is defined as the circumference of the gemstone.

After determining the circumference and center of the gemstone, the three algorithms are run to measure the three optical properties (brilliance, scintillation and symmetry) for pixels contained within the circumference, excluding pixels outside the circumference.

The purpose of the gemstone look-up module 90 is also to view previously generated reports on gemstones. The generated gemstones reports are retrieved either from gemstone database 18 on server 14 or from a database, such as live experience database 112 on computer 10 through server 14. Gemstone look-up module 90 is preferably implemented as a Java applet that is associated with corresponding user interface pages. The Java applet is programmed to receive an entered code that comprises a sequence of alphanumeric characters.

FIG. 5D is a flow diagram that shows the process followed by main control program 88 from point D. At step 166, a user experience menu page is displayed. At step 168, it is determined whether the user has selected a remote evaluator mode. If this is the case, the process continues to point E. If not, the process continues to step 170, where it is determined whether the user has selected remote buy mode. If so, the process continues to point F. If this is not the case, the process continues to step 172, where it is determined whether the user has selected remote gemstone comparison mode. If this is the case, the process continues to point G. If not the case, the process continues to step 174. At process 174, it is determined whether the user has selected remote gemology teaching mode. If so, the process continues to H. If not, the process continues to point C.

FIG. 5E is a simple flow diagram that shows the process followed by main control program 88 from point E. At step 176, the remote authorization and authentication system validates the access granted to the remote evaluator. The remote evaluator may be selected by the user for remote evaluation from a list of remote evaluators that are online and/or from remote evaluators. The user controls the privileges that are available to the remote buyer and decides whether to grant full or partial access to the gemstone evaluation module. At 176, it is determined whether the authorization of the remote evaluator is successful. If this is the case, the process continues to step 180, where instant messaging and conferencing facility is enabled for the remote evaluator. The process then continues to point C. If not, the process continues to point I.

FIG. 5F is a flow diagram that shows the process followed by main control program 88 from point F. At step 182, the remote authorization and authentication system validates the access granted to remote buyer. The remote buyer may be invited or selected by the user for remote buying from a list of buyers that are online and/or from remote buyers that have expressed interest in buying the gemstones from the user, such as a retailer. The user controls the privileges that are available to the remote buyer and decides whether to grant full or partial access to the gemstone evaluation module running on the user's computer. At 184, it is determined whether the authorization and authentication of the remote buyer is successful. If this is the case, the process continues to step 186, where instant messaging and conferencing facility is enabled for the remote buyer to communicate with the user. The process then continues to step 188. If not, the process continues to I. At step 188, it is determined whether the buyer has searched and selected gemstones from the gemstone database 54. If so, the process continues to point C. If not, the process continues to point I.

FIG. 5G is a simple flow diagram that shows the process followed by main control program 88 from point G. At step 190, the remote authorization and authentication system validates the remote user, such as a retailer or a buyer or a seller. The retailer, buyer, or seller is then invited by the user for remote comparison and evaluation.

At 192, it is determined whether the authorization and authentication of the remote user for remote comparison and evaluation is successful. If so, the process continues to step 194, where an instant messaging and conferencing facility is enabled for the remote user invited for remote comparison. The process then continues to step 196. If not, the process continues to process I. At step 196, at the same time, the gemstone data of the remote user is received and displayed on the gemstone evaluation screen of the user and the remote user. The process continues then to step 198, where at the same time, the gemstone data of the user is transmitted to the gemstone evaluation screen of the user and the remote user. The process then continues to point I.

FIG. 5H is a simple flow diagram that shows the process followed by main control program 88 from point H. At step 200, the remote authorization and authentication system validates the remote tutor who is invited by the user for remote tutoring. The remote tutor may be invited or selected by the user for remote buying from a list of tutors that are online and/or the selection of the remote tutor may be predetermined. At 202, it is determined whether the authorization and authentication of the remote tutor is successful. If so, the process continues to step 204, where instant messaging and conferencing facility is enabled for the remote user invited for remote comparison to communicate with the user. The process continues to C. If not, the process continues to I.

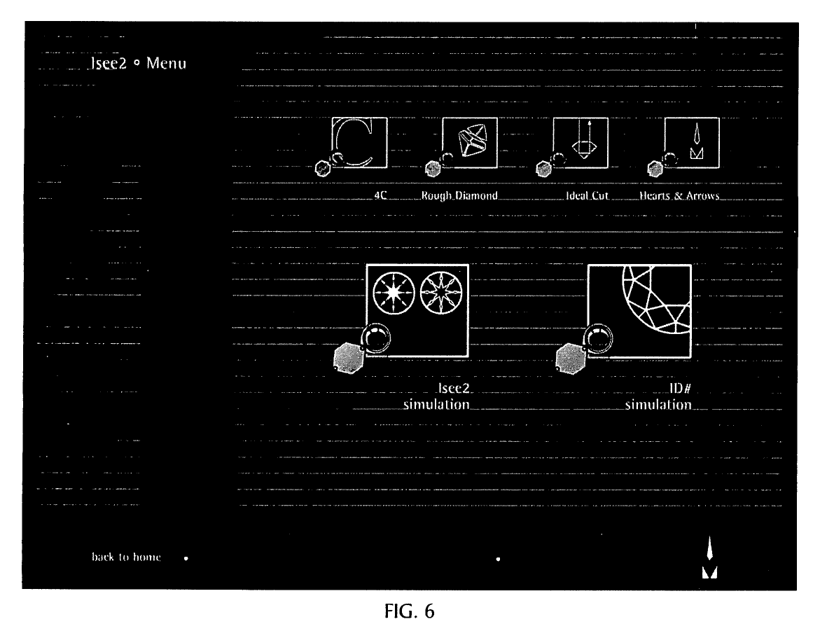

FIG. 6 shows the main menu screen presented to the user of the present invention. Four small icons that represent the 4 C's, rough diamond, ideal cut, hearts and arrows are displayed in a row. The four icons correspond to four different sections that the user can select from gemology teaching pages. Two larger icons, one for using the optical property evaluation module 92 on the left, and the gemstone report look-up module 90 on the right, are placed beneath the four small icons. The user chooses to click on any of these icons to activate the corresponding gemology page or module.

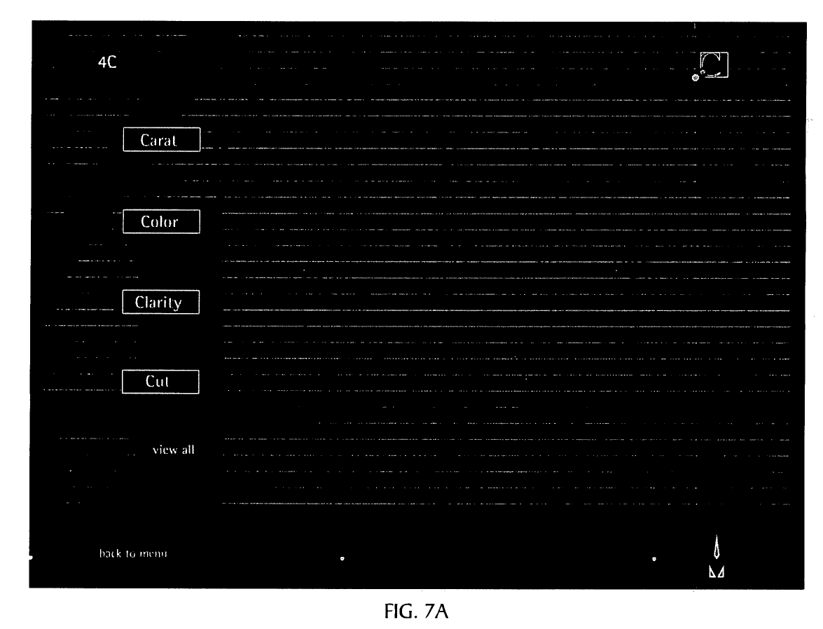

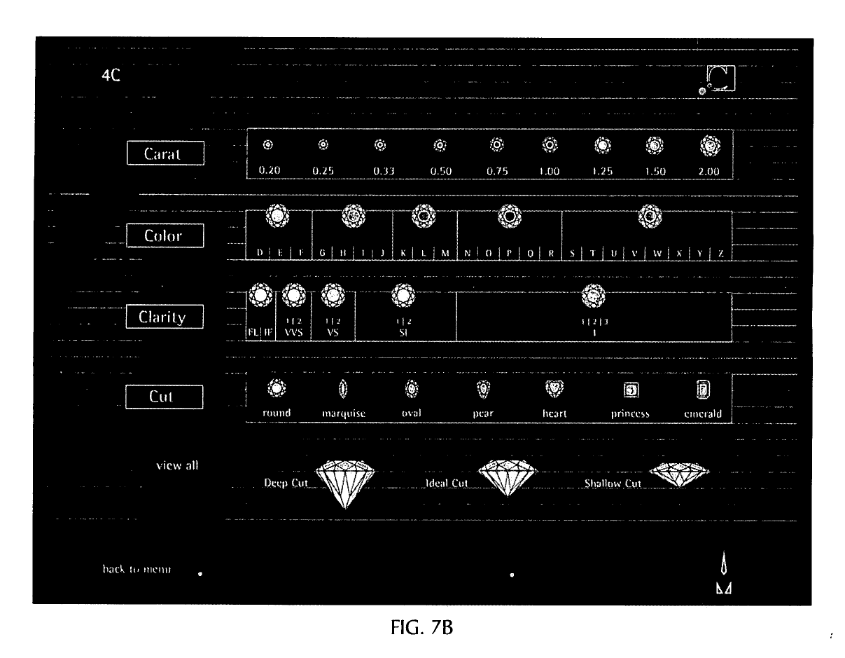

FIGS. 7A and 7B show screenshots representing gemology teaching pages relating to the 4 C's: carat, color, clarity and cut. These 4 C's are represented on the screen by four boxes. The user moves the mouse pointer over any of the four boxes to select one of the 4 C's. Appropriate graphic representation explaining the property is displayed to the right of the selected box. As shown in FIG. 7B, to display all the representations of the 4 C's, the text “view all” below the four boxes is selected by moving the pointer over it.

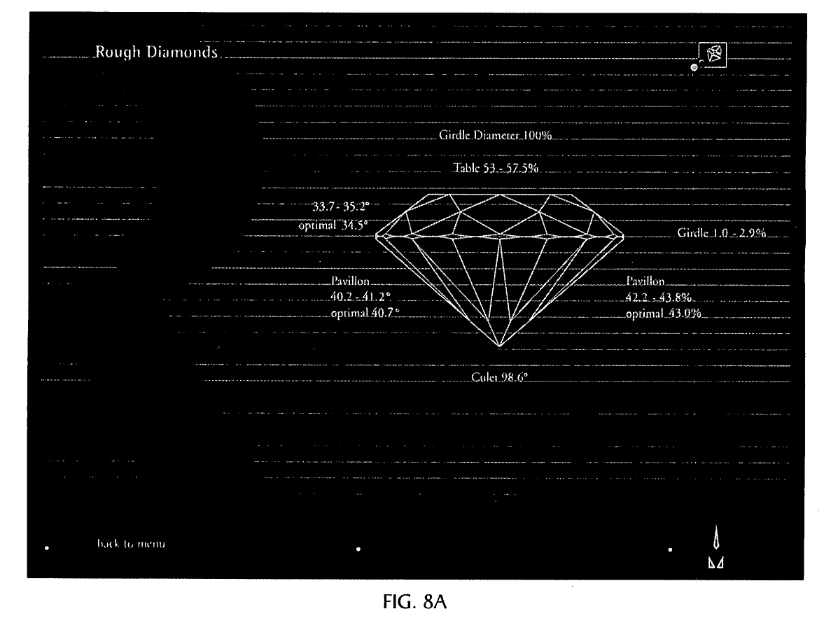

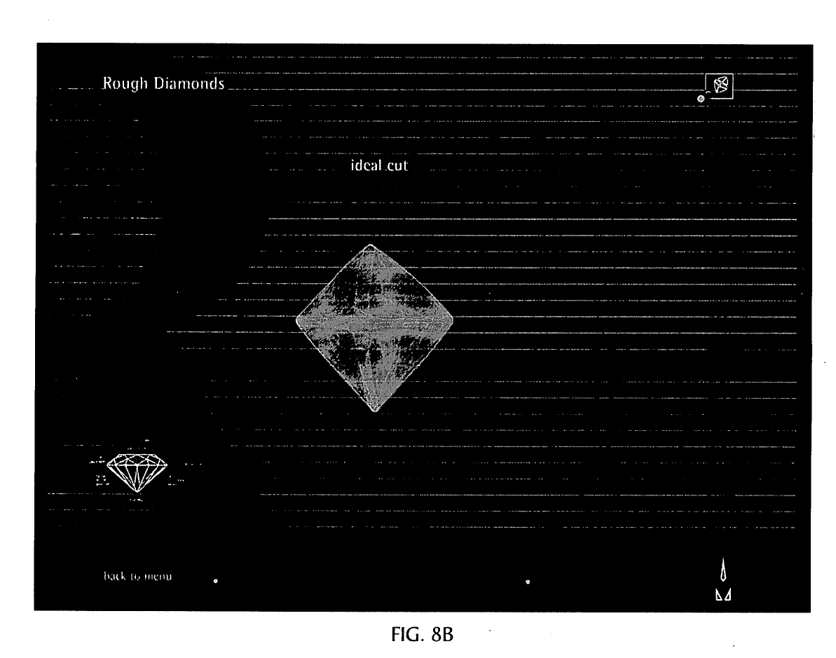

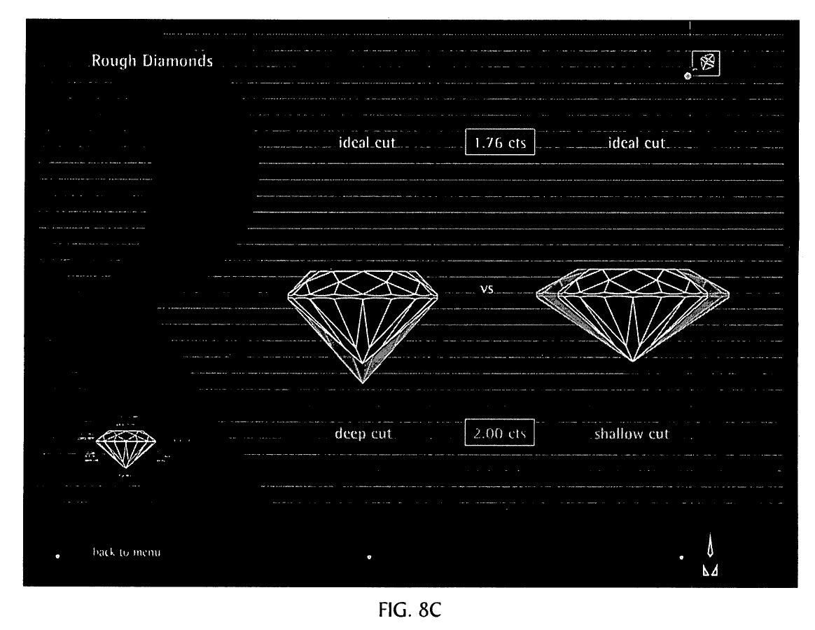

FIGS. 8A and 8B show screenshots that represent the process that a rough diamond undergoes before becoming an ideal cut diamond. The screenshots in this category of gemology teaching pages explain the difference between shallow, deep, and ideal SRB cut diamonds. The difference is explained in terms of the process of cutting a rough diamond and of the carat weight. A moving image presentation executed using Adobe Flash components starts at FIG. 8A that shows a first rough ready to be cut and ends at FIG. 8B, which shows the first and second roughs with the excess stone above the table cut away. Also, the end of FIG. 8B shows both the deep and shallow SRB cuts and the ideal cuts overlaid. As shown in FIG. 8C, a small icon showing a side-on image of a SRB cut diamond is shown in each gemology teaching page so that the user may select it which details the optimal cut proportions of an ideal cut SRB

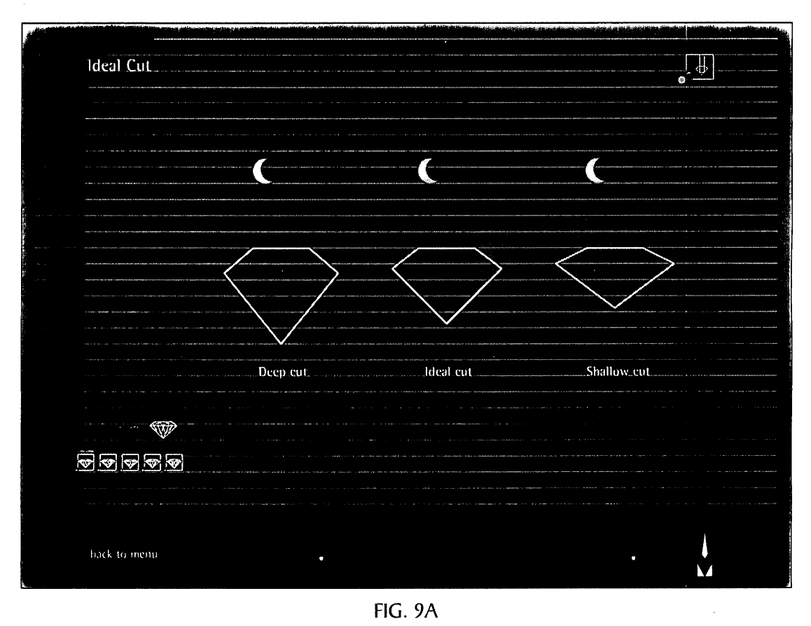

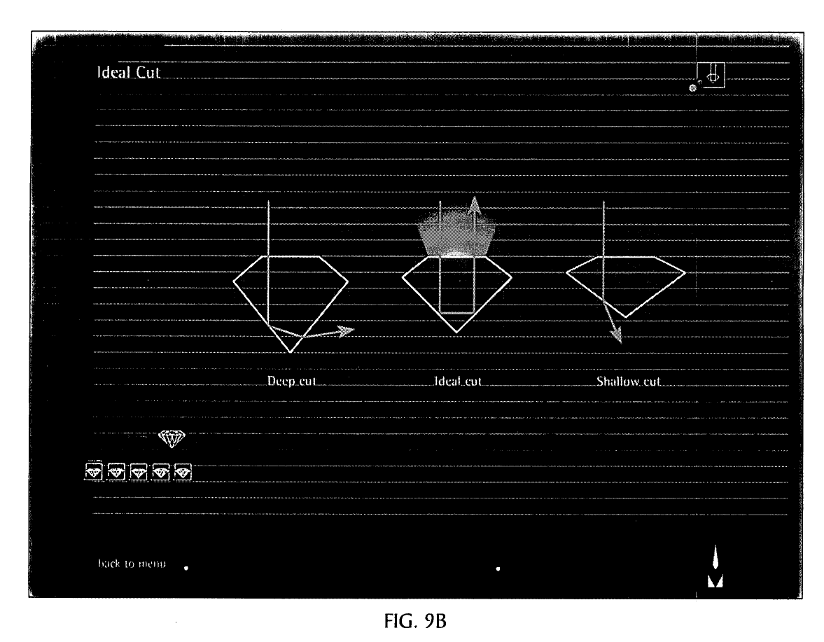

FIG. 9A-9B show screenshots that represent gemology teaching pages explaining the differences in light handling ability between deep, shallow, and ideal cut SRB cut diamonds. The moving image presentation executed using Adobe Flash components starts at FIG. 9A that shows three side-on outlines of three SRB cut diamonds. The three diamonds are in relative darkness, as indicated by the computer image. As the Adobe Flash presentation moves forward, the effect the cut has on light handling ability in terms of the light returned through the table is highlighted in the presentation. The presentation ends at FIG. 9B which shows the light ray traced as it enters the diamond, reflected off the internal surface of one of the pavilion facets, and again reflected off the internal surface of another facet on the other side of the pavilion and directed back through the table where it exits.

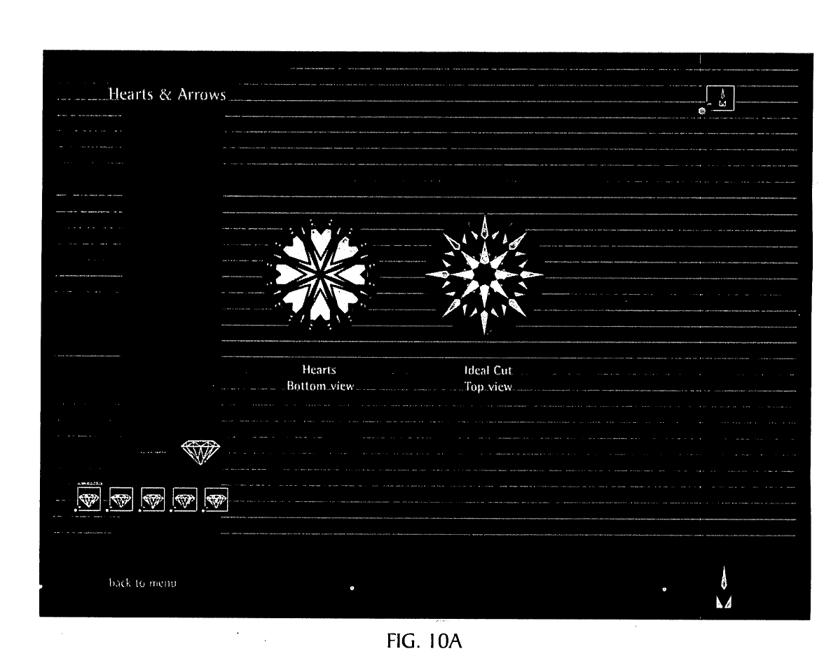

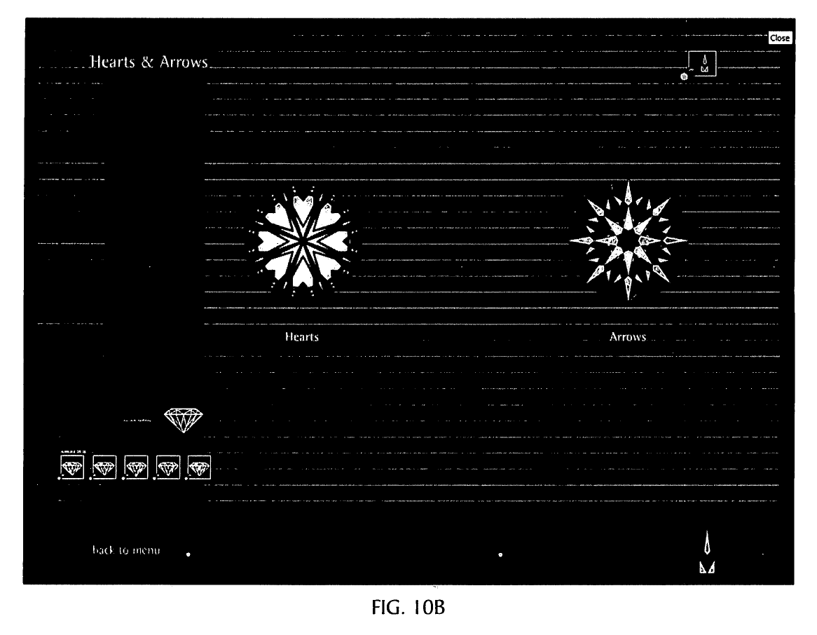

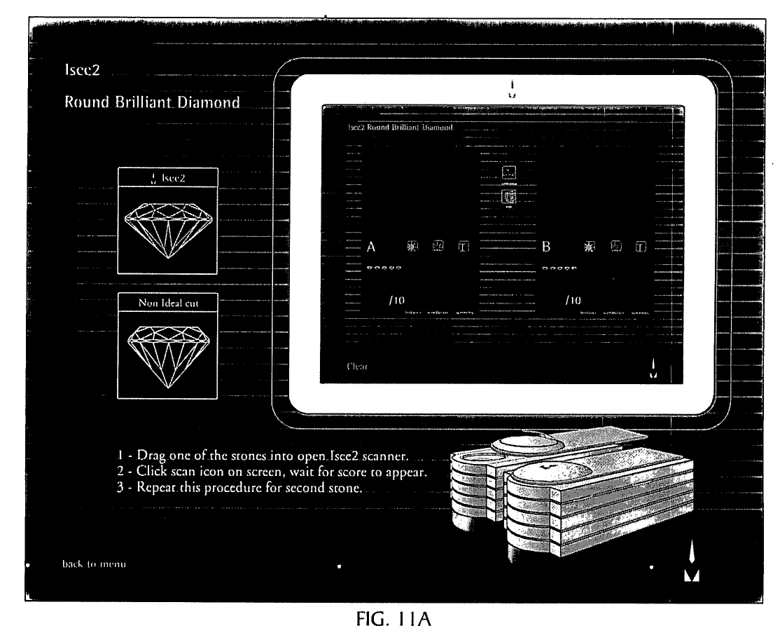

FIGS. 10A and 10B, show screenshots that represent the gemology teaching pages that explain how an ideal SRB cut diamond is cut from a rough to produce the phenomenon of “hearts and arrows” in a well-cut diamond. FIG. 10A shows a rough being cut into two parts. The presentation shows how the rough parts with the excess stone around the girdle and girdle facets, major pavilion-side facets, and minor pavilion-side facets are cut away to produce a clearly visible “hearts” pattern with 8 hearts and “arrows” pattern with 8 aligned arrows arranged around the center of the stone. At the end of the presentation, the user can clearly see the “hearts and arrows” patterns produced by a well-cut ideal SRB cut diamond.

A spoken narrative explaining the meaning of the 4 C's, the difference between shallow, deep, and ideal cut SRB cut diamond in terms of both carat weight and light handling ability, and the phenomenon of “hearts and arrows” produced by a well-cut ideal SRB cut diamond is presented. This presentation may also include the gemology pages along with written description. The presentation is also preferably provided with instant messaging module that facilitates audio, visual, textual interaction between plurality of users, such as retailers, buyers, evaluators, and tutors over the internet 16 and via server 14.

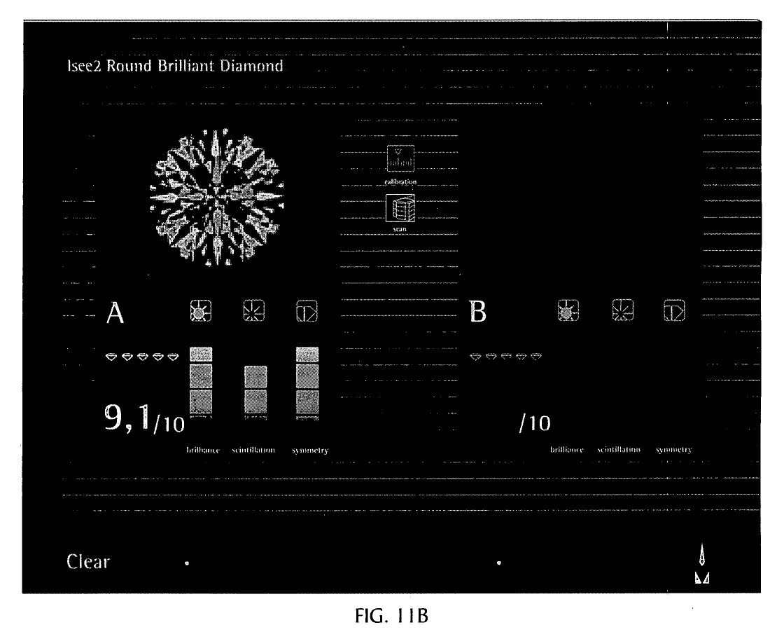

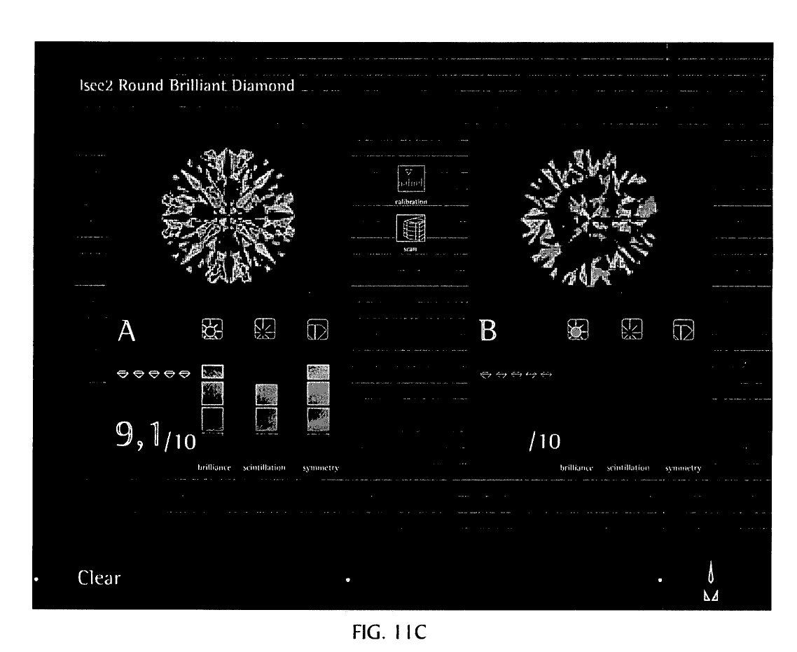

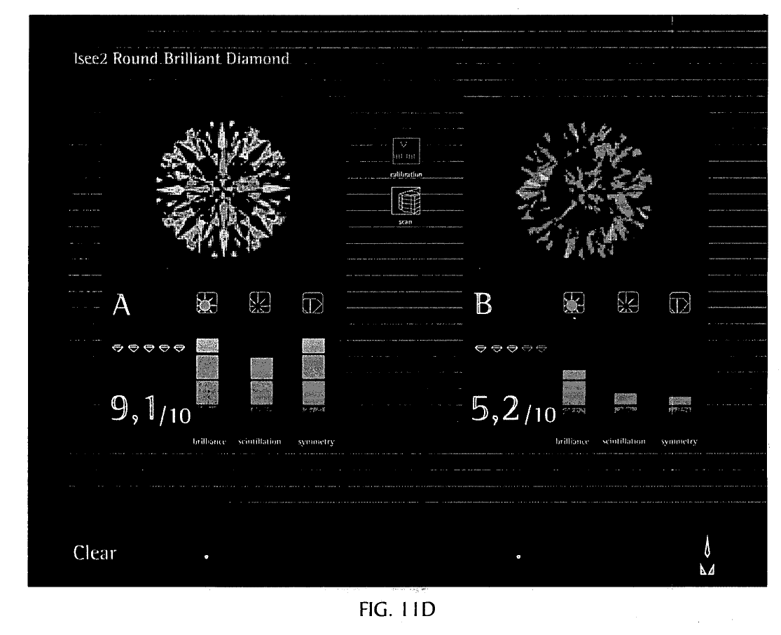

FIG. 11A shows a screen shot of the main screen of the optical property evaluation module 92. There are two boxes on the right and left sides of the main menu screen for displaying images and optical properties of two different diamonds. The two diamonds are captured in separate scanning operations using single apparatus 34 or using two different apparatus of two users connected over the internet 16 via server 14. An image of a diamond on the right or left sides of the main menu screen may be a “live” image being captured by camera 80 connected to a local computer or a remote computer transmitting the image via the internet. The image may also be or a “video” image of a previously captured image during a scanning operation and stored in the hard disk drive of the computer or the database on the internet.

FIG. 11B shows a screenshot of the initial scanning screen of the optical property evaluation module 58 without a diamond 80 in the apparatus 34. Initially, the diamond 80 is manually placed table-side down on the platform and centered approximately on axis 76. Then, by clicking once on the “Scan” button, optical property evaluation module 92 is instructed to perform a scan of the diamond 60 and to determine and display representations of three optical properties: brilliance, scintillation, and symmetry. Frames taken from camera 80 at each of these positions are stored in the hard disc drive of the computer 10 and on gemstone database 54 on server 14 over the internet for later display and analysis.

As shown in FIG. 11C, the results of analysis that comprises measurements of brilliance, scintillation, and symmetry are then displayed beneath the image of the diamond as bar graph representations along with a score out of 10. For objective measurements of the optical properties of brilliance, scintillation, and symmetry, a user can compare two diamonds scanned either in two separate scanning operations using one apparatus 34 or two separate scanning operations using two apparatuses 34 coupled to computer 10. The user can use apparatus 10 coupled to two different computers located at two different geographical locations either connected via internet 16 and server 14 or connected via intranet 24 and proxy server 26. The results are displayed on the screens of local computer 10 and the remote computer 10 at the same time. It should be noted that the results can also be displayed on internet devices 12, such as cellular phones and PDAs, which are connected to the computer 10 coupled to the apparatus 34.

FIG. 11D shows a screen shot of the optical property evaluation module 92 with an image of the first diamond. The diamond's optical properties are displayed in the left hand box and an image of the newly placed other diamond in the right hand box. The optical evaluation module 92 is instructed to perform a scan of the newly placed diamond and to determine and display representations of three optical properties as well as the total score out of 10.

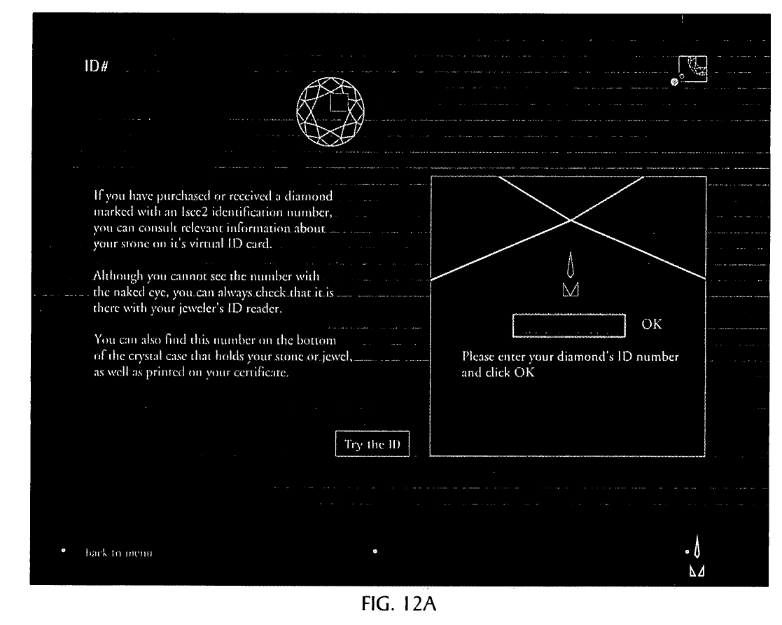

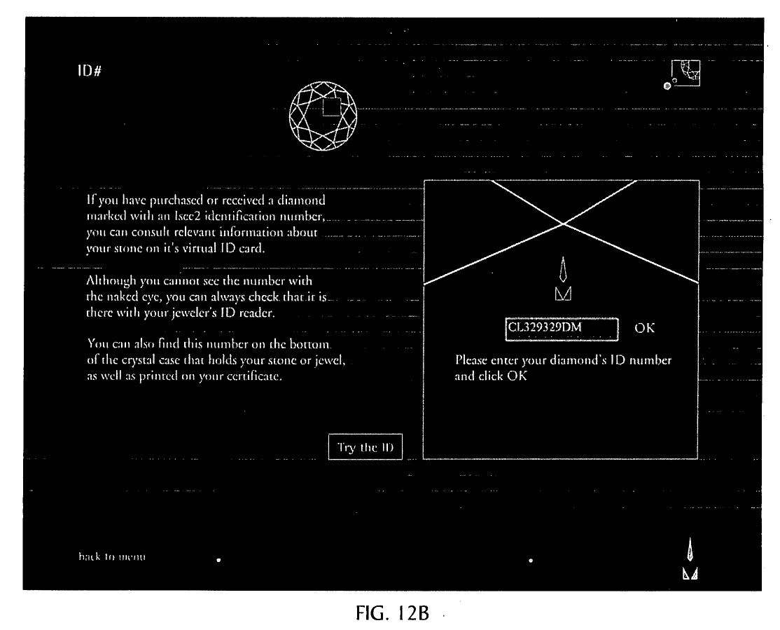

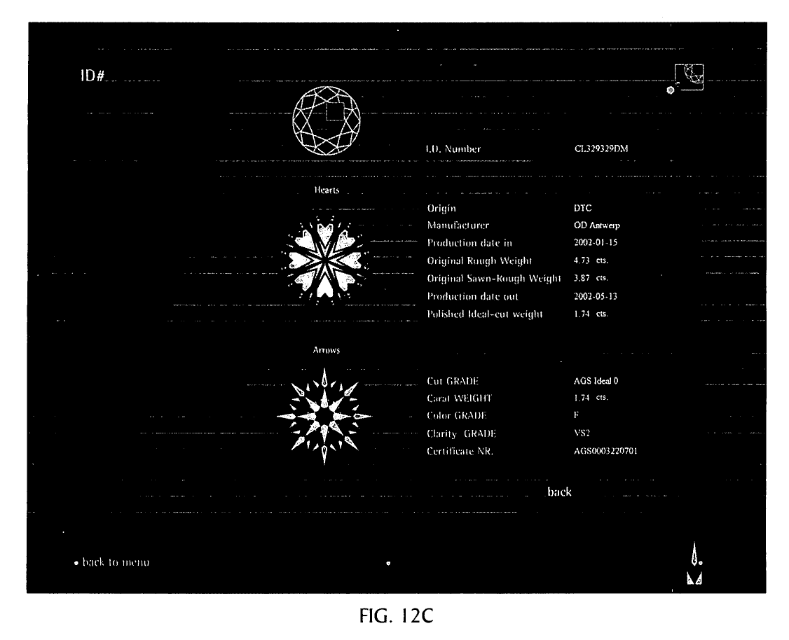

FIG. 12A shows a screenshot of the user interface screen of the gemology teaching and gemstone evaluation application. The screen shows a user entry box for entering a diamond's unique ID number. FIG. 12B shows the user interface screen with a diamond number entered in the user entry box by typing at the keyboard of the computer 10. Referring to FIG. 12C, by clicking on the “OK” button to the right of the user entry box, the gemstone look-up module 90 is instructed to look up a previously generated record for the identified diamond and to display the record. These records display information relating to the origin and manufacturing of the cut diamond, the origin of the rough diamond, and the manufacturer of the cut diamond. The records also display the weight of the original rough and the polished ideal cut diamond, as well as the date of production of the cut diamond. Finally, the records also display the information regarding the grading of the cut diamond, the carat weight, color grad, clarity grade, and certificate number.

In Operation

The present invention is primarily aimed at individual users interested in buying gemstones over the internet. The user in the primary role of an individual buyer connects to the server computer using a program preferably stored on a local internet enabled device, such as a laptop/computer. The internet enabled device may also be connected to the internet enabled devices of remote users, such as retail outlets and individual sellers via the server computer.

The preferred process of buying gemstones over the internet using the present invention is as follows:

The user wanting to buy or examine gemstones over the internet searches for the gemstones available for sale on the internet. The user requests the server computer or the remote user, such as a retail outlet connected to the server computer, to display relevant gemstone data on the local internet enabled device, such as a workstation, laptop, cellular phone, or PDA. The data may either be an image data that relates to gemstone properties, such as 4 Cs in the case of the diamond, or the information regarding the origin of the gemstone. The user may request the server computer or a remote user to obtain live image data of the gemstone. It should be noted that apart from providing live image data, the server computer can also provide to the user recorded image data of gemstones available for sale. It should be further noted that the user is also able to capture and view the image data using the camera via the server computer at various suitable magnifying options.

Upon request, the gemstone is placed in the apparatus and generated data is sent to the user computer and the image data is displayed on the user computer. Using the gemstone evaluation module, the user analyzes information including the virtual “hearts and arrows” patterns to understand the visual symmetry and studies the 4 ‘C’ rating of diamond. Usually there is another diamond shown so that the user can compare the diamond with that diamond. On arriving at a buying decision, the user places an order for the diamond. The user can place the order for the gemstone over the internet and receive the gemstone at his doorstep via mail. Once the order for a diamond is placed, the user can also visit the retail outlet and collect the gemstone over the counter.

It should also be noted that when interacting with other users directly via the server computer, the user can also give access to the data collected by the gemstone evaluation apparatus connected to the local computer and can get access to the data collected by the gemstone evaluation apparatus connected to the remote computer.

In summary, the present invention allows many ways of buying and examining diamonds: 1) examining and purchasing a diamond or gemstone online or examining a diamond online and purchasing it at a retail establishment; 2) conferencing with the seller and/or other persons online to examine the diamond online and purchasing it online or at a retail establishment; and 3) examining the diamond through virtual equipment online and then purchase the diamond online or at the retail establishment.

Thus, it can be seen that the present invention provides an easy, accessible and user-friendly method and system for a user to measure the optical properties of one or more diamonds and to buy and purchase diamonds.

The embodiments of the invention shown and discussed herein are merely illustrative of modes of application of the present invention. Reference to details in this discussion is not intended to limit the scope of the claims to these details, or to the figures used to illustrate the invention.

What is claimed is:

1. A method of evaluating a gemstone over the internet, the method comprising the steps of:
providing a server computer, providing access to an internet enabled device that is connectable to an apparatus capable of capturing an image of a gemstone;
connecting the device to a second device through the server; and
transmitting data over the internet of a received image of the gemstone to determine one or more optical properties of the gemstone.

2. The method of claim 1, further comprising the step of: examining and purchasing a diamond or a gemstone online.

3. The method of claim 1, further comprising the step of: examining a diamond or gemstone online and purchasing it at a retail establishment.

4. The method of claim 1, further comprising the step of: conferencing with a seller or other persons online to examine the diamond online.

5. The method of claim 4, further comprising the step of: purchasing the diamond online.

6. The method of claim 4, further comprising the step of: purchasing the diamond at a retail establishment.

7. The method of claim 1, further comprising the step of: presenting, on a display of the second device, a series of screens comprising a graphical representation how a cut of a gemstone affects its light handling ability.

8. The method of claim 1, further comprising the step of: presenting, on a display of the client device, a user interface screen, the user interface screen configured to allow controlling the apparatus to measure tone or more optical properties of a particular gemstone provided to the apparatus, viewing an image of the gemstone so measured, and viewing representations of the measured one or more optical properties.

9. The method of claim 1, further comprising the step of: examining the diamond through virtual equipment online and purchasing the diamond online.

10. The method of claim 1, further comprising the step of: examining the diamond through virtual equipment online and purchasing the diamond at a retail establishment.

11. The method of claim 7, wherein the series of screens comprises a graphical representation of the light handling phenomenon of a standard round brilliant cut.

12. The method of claim 11, wherein the light handling phenomenon is a hearts and arrows pattern.

13. The method claim 12, further comprising the step of: applying a program using a virtual hearts and arrows pattern to enable the consumer to view the visual symmetry of a diamond online.

14. A system for gemstone evaluation over the internet, the system comprising: a server computer having:
a client device connectable to the internet for transmitting gemstone images and evaluating data;
means for processing an image of a gemstone received from the apparatus to determine one or more optical properties of the gemstone; and
means for presenting, on the display, the received image of the gemstone and representations of the determined one or more optical properties.

15. The system of claim 14 including means for purchasing the diamond online.

16. The system of claim 14 including means for examining the diamond online and purchasing it at a retail establishment.

17. The system of claim 14 including means for conferencing with a seller or other persons online to examine the diamond.

18. The system of claim 17 including means for purchasing the diamond online.

19. The system of claim 17 including means for purchasing the diamond at a retail establishment.

20. The system of claim 14 including means for presenting, on a display of the second device, a series of screens comprising a graphical representation how a cut of a gemstone affects its light handling ability.

21. The system of claim 14 including means for presenting, on a display of the client device, a user interface screen, the user interface screen configured to allow controlling the apparatus to measure tone or more optical properties of a particular gemstone provided to the apparatus, viewing an image of the gemstone so measured, and viewing representations of the measured one or more optical properties.

22. The system of claim 14 including means for examining the diamond through virtual equipment online and purchasing the diamond online.

23. The system of claim 14 including means for examining the diamond through virtual equipment online and purchasing the diamond at a retail establishment.

24. The system of claim 20, wherein the series of screens comprises a graphical representation of the light handling phenomenon of a standard round brilliant cut.

25. The system of claim 24, wherein the light handling phenomenon is a hearts and arrows pattern.

26. The system of claim 25, including means for applying a program using a virtual hearts and arrows pattern to enable the consumer to view the visual symmetry of a diamond online.
